(19) United States
(12) Patent Application Publication
(10) Pub. No.: US 2022/0042189 A1
(43) Pub. Date: Feb. 10, 2022

(54) ANODES COMPRISING TRANSITION METAL AND PLATINUM GROUP METAL AS ALLOYS, AND RELATED METHODS AND SYSTEMS

(71) Applicant: Battelle Energy Alliance,LLC, Idaho Falls, ID (US)

(72) Inventor: Prabhat K. Tripathy, Idaho Falls, ID (US)

(21) Appl. No.: 17/444,482

(22) Filed: Aug. 5, 2021

Related U.S. Application Data
(60) Provisional application No. 62/706,219, filed on Aug. 5, 2020.

(51) Int. Cl. C25B 11/091; C25D 3/50; C25B 11/053; C25B 9/17; C25B 11/02

(52) U.S. Cl. CPC C25B 11/091; C25D 3/50; C25B 11/02; C25B 9/17; C25B 11/053

(57) ABSTRACT

Disclosed are anodes for an electrochemical reduction system, such as for the electrochemical reduction of oxides in systems using molten salt electrolytes. The anodes comprise a rod or plate formed of and include at least one alloy of at least one transition metal and at least one platinum group metal. The alloy anodes may be less expensive than anodes formed solely from platinum group metals and may exhibit less material attrition than anodes formed solely from transition metals. Related methods and electrochemical reduction systems are also disclosed.

### CROSS-REFERENCE TO RELATED APPLICATION

This application claims the benefit under 35 U.S.C. § 119(e) of U.S. Provisional Patent Application Ser. No. 62/706,219, filed Aug. 5, 2020, the disclosure of which is hereby incorporated in its entirety herein by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The disclosure, in various embodiments, relates generally to anodes for the electrochemical reduction of oxides (e.g., in electrochemical reduction systems (e.g., cells)) and to systems including such anodes. More particularly, this disclosure relates to anodes—and to systems including anodes—configured for use in electrochemical reduction cells for the conversion of metal oxides to their constituent metals, which anodes comprise alloys of at least one transition metal and at least one platinum group metal.

### BACKGROUND

Electrochemical conversion of metal oxides to their constituent metals offers several techno-economic advantages, and so such conversions are being pursued in an effort to develop cost-effective and energy-efficient manufacturing processes for the production of engineering materials and critical elements. A conventional electrochemical reduction cell—as currently used in industry for electrochemical metal-oxide-to-metal conversions—contains an anode, a cathode, an electrolyte containing the metal(s) of interest, and a power supply (e.g., a direct current (DC) power supply). Depending on the metal to be produced, both metals and non-metals have been used as anodes and cathodes in conventional electrochemical reduction cells.

Anode materials, employed in the electrochemical reduction processes, to prepare metals or metal alloys in one-unit (e.g., one electrochemical reduction cell) operations have been primarily of two types: metallic and non-metallic. In electrochemical reduction systems using molten salt media as the electrolyte material (e.g., in molten-salt-based oxide reduction processes), conventional metallic anode materials include, for example, precious metals, e.g., platinum group metals, while conventional non-metallic anode materials include, for example, graphite, cermets, and oxides.

Platinum group metals (i.e., platinum (Pt), ruthenium (Ru), rhodium (Rh), palladium (Pd), osmium (Os), and iridium (Ir)) have shown real promise, at least as a short-term solution. However, the biggest impediment on the possible use of platinum as the oxygen-evolving electrode (e.g., the anode) is its prohibitive cost. Moreover, platinum has been observed not to be the ideal material, even as a short-term solution, in certain electrolyte systems, such as in lithium-chloride-based melts (e.g., LiCl-based molten salt media electrolytes). For example, upon long-term exposure in high-temperature systems (e.g., as in many molten salt-based systems), platinum anodes tend to degrade because of the combined effects of high temperatures (e.g., temperatures greater than 600° C.) and of highly-oxidizing environments. Compared to platinum, other platinum group metals (e.g., iridium and ruthenium) may exhibit comparatively better performance characteristics under similar circumstances to those at which platinum anodes tend to degrade. However, the high cost of other platinum group metals is also a deterrent factor for their potential commercial use. Among the platinum group metals, ruthenium may be the least expensive, but even this least-expensive platinum group metal is still greater than about $700 per troy ounce (per about 31 g).

Outside of platinum group metals, but within the broader noble metal (e.g., precious metals) category, cost is also a deterrent factor. For example, the use of gold as an anode for an electrochemical reduction system would tend to be highly cost prohibitive.

While platinum may be used in some specialized processes (e.g., the electrolytic reduction of actinides), efforts have been made to investigate graphite and other materials as potential, future anode materials. Use of graphite has been very well documented in open literature, both in terms of its advantageous features (e.g., it is relatively inexpensive) and in terms of its technical difficulties (e.g., concerning overall process efficiency, carbon contamination of electrolytes, formation of metal carbide at the cathode, short-circuiting the anode-cathode connection, etc.). As for metallic anode materials, doped nickel ferrites have been tested in the aluminum industry with limited success. Among the nonmetallic anodes being investigated, both cermets (a combination of ceramic compounds and metals, hence the name “cermet”) and oxides (e.g., tin oxide (SnO₂)) have been extensively investigated as potential inert anode materials, both in the aluminum industry as well as in the production of non-aluminum metals. However, cermets and oxides do not show long-term promise as anode materials. Also, their fabricability is another area of concern.

Accordingly, designing anodes for electrochemical reduction processes, including electrochemical reduction processes using molten salt-based media, continues to present challenges. Moreover, the absence of a suitable anode material appears to be a notable deficiency in the present developmental effort pertaining to the commercial scale production of electrolytic-grade engineering metals and alloys directly from their oxide/mixed-oxide intermediates. The development of anodes that are both effective (e.g., inert to the environments in which they will be used) and relatively inexpensive and that exhibit better or at least comparable performance characteristics, at least compared to conventional anodes for electrochemical reduction processes, remains a challenge.

### BRIEF SUMMARY

Various embodiments of the disclosure provide anodes configured for electrochemical reduction systems, such as electrochemical reduction systems using molten salt electrolytes, wherein the anodes are formed from and include alloy(s) of at least one transition metal and at least one platinum group metal. The alloy anodes may be relatively less expensive than conventional anodes for such systems and yet still effective.

In some embodiments, disclosed is an anode for an electrochemical reduction system. The anode comprises a rod or plate comprising at least one alloy of (1) at least one transition metal; and (2) at least one platinum group metal.

In some embodiments, disclosed is a method of forming an anode for an electrochemical reduction system. The method comprises forming a rod or plate comprising at least one alloy. The method also includes forming the at least one alloy of (1) at least one transition metal and (2) at least one platinum group metal.

In some embodiments, disclosed is an electrochemical reduction system. The system comprises a counter electrode comprising at least one alloy of at least one platinum group metal and at least one transition metal. The electrochemical reduction system also comprises an electrolyte comprising a molten salt.

### BRIEF DESCRIPTION OF THE DRAWINGS

FIG. 1A is an elevational, cross-sectional, schematic illustration of an anode formed of and including alloys of at least one transition metal and at least one platinum group metal, in accordance with embodiments of the disclosure, wherein the anode includes a gradient of varying alloy compositions.

FIG. 1B is a top plan, cross-sectional, schematic illustration of the anode of FIG. 1A.

FIG. 2A is an elevational, cross-sectional, schematic illustration of an anode formed of and including alloy(s) of at least one transition metal and at least one platinum group metal, in accordance with embodiments of the disclosure, wherein the anode has a substantially homogeneous alloy composition.

FIG. 2B is a top plan, cross-sectional, schematic illustration of the anode of FIG. 2A.

FIG. 3 is a simplified schematic of a system with an electrochemical cell for direct oxide reduction, in accordance with embodiments of the disclosure.

FIG. 4A is a photograph showing a monolithic ruthenium anode prior to use.

FIG. 4B is a photograph showing the monolithic ruthenium anode of FIG. 4A after use in a calcium-chloride-calcium-oxide melt during the electrochemical reduction of tantalum oxide (Ta₂O₅).

FIG. 5 is a chart showing a cyclic voltammogram of the evolution of bromine gas during the electrochemical decomposition of LiBr in a eutectic LiBr—KBr electrolyte at 400° C.

FIG. 6 is a photograph showing a ruthenium anode (on the left-side of the photograph) and a platinum anode (on the right-side of the photograph) after use in a calcium-chloride-calcium-oxide melt during the electrochemical reduction of tantalum pentoxide at 900° C.

FIG. 7A is a photograph showing a ruthenium anode after use in a calcium-chloride-calcium-oxide melt during the electrochemical reduction of tantalum pentoxide at 900° C.

FIG. 7B is a photograph showing a ruthenium-molybdenum alloy, in accordance with embodiments of the disclosure, after use in a calcium-chloride-calcium-oxide melt during the electrochemical reduction of tantalum pentoxide at 900° C.

### DETAILED DESCRIPTION

Disclosed are anodes (e.g., oxygen-evolving electrodes)—for electrochemical reduction systems, such as molten salt-based electrochemical reduction systems—that include at least one alloy of at least one transition metal and at least one platinum group metal. Such alloy anodes may not exhibit perceptible attrition or mechanical degradation under continuous bubbling of oxygen on their surfaces at elevated temperatures, e.g., in molten salt-based electrochemical reduction systems.

As used herein, the terms “anode” and “counter electrode” may be used interchangeably.

As used herein, the terms “cathode” and “working electrode” may be used interchangeably.

As used herein, the term “TM” means and refers to a “transition metal.”

As used herein, the term “PGM” means and refers to a “platinum group metal.”

As used herein, the term “TM-PGM alloy” means and refers to an alloy comprising, consisting substantially of, or consisting of at least one transition metal and at least one platinum group metal.

As used herein, the term “binary alloy” means and refers to an alloy of two metals.

As used herein, the term “ternary alloy” means and refers to an alloy of three metals.

As used herein, the terms “molten salt” and “melt” mean and refer to molten media, which may or may not be wholly ionic or derived from simple salts.

As used herein, the term “molten salt systems” means and refers to electrochemical systems (e.g., electrochemical reduction systems) utilizing a molten salt electrolyte.

As used herein, the term “high temperature” means and refers to temperature(s) exceeding about 550° C.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may,” when used with respect to a material, structure, feature, or method act, indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, even at least 99.9% met, or even 100.0% met.

As used herein, the terms “about” and “approximately,” when either is used in reference to a numerical value for a particular parameter, are inclusive of the numerical value and a degree of variance from the numerical value that one of ordinary skill in the art would understand is within acceptable tolerances for the particular parameter. For example, “about” or “approximately,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, “and/or” includes any and all combinations of one or more of the associated listed items.

As used herein, the singular forms “a,” “an,” and “the” are intended to include the plural forms as well, unless the context clearly indicates otherwise.

As used herein, a “(s)” at the end of a term means and includes the singular form of the term and/or the plural form of the term, unless the context clearly indicates otherwise.

The following description provides specific details, such as material types and processing conditions, in order to provide a thorough description of embodiments of the disclosed materials and methods. However, a person of ordinary skill in the art will understand that the embodiments of the materials and methods may be practiced without employing these specific details. Indeed, the embodiments of the apparatus, systems, and methods may be practiced in conjunction with conventional techniques employed in the industry.

The processes described herein do not form a complete process flow for the related methods. The remainder of the methods are known to those of ordinary skill in the art. Accordingly, only the methods and conditions necessary to understand embodiments of the present materials and methods are described herein.

Reference will now be made to the figures, wherein like numerals refer to like components throughout. The drawings are not necessarily drawn to scale.

Anodes of embodiments of the disclosure are formed of and include at least one alloy of at least one platinum group metal (e.g., ruthenium (Ru)) with at least one transition metal (e.g., molybdenum (Mo), titanium (Ti)). The resultant alloy (e.g., transition-metal-platinum-group-metal alloy (TM-PGM alloy)) may exhibit better, or at least similar performance characteristics, compared to conventional anodes for electrochemical reduction systems and may be relatively more durable (e.g., exhibit more resistance to oxygen at elevated temperatures) than if, e.g., fabricated from substantially only transition metal(s). Moreover, the TM-PGM alloy anodes may be relatively less costly compared to, e.g., anodes formed substantially from platinum group metals, and may be about as effective or more effective—e.g., for use in oxide reduction technologies (e.g., electrochemical reduction systems)—than if fabricated substantially from PGM(s) alone. Accordingly, the combination of the transition metal(s) and the platinum group metal(s) in alloy form may provide twin characteristics: relatively good corrosion resistance and relatively good resistance to chemical degradation by reactive oxygen at elevated temperatures.

Alloying of transition metal(s) and platinum group metal(s) may result in formation of two compositions: intermetallic compounds and solid solutions. Both of these composition types may be suitable inert anode materials. Solid solution compositions may also be relatively less susceptible to brittle fracture. Accordingly, in some embodiments, the TM-PGM alloy anode may be formed to comprise, consist substantially of, or consist of solid solution TM-PGM alloy(s). In other embodiments, the TM-PGM alloy anode may include intermetallic compounds of the TM(s) and PGM(s).

The at least one platinum group metal—of the alloy of the TM-PGM alloy anode—may be ruthenium (Ru), rhodium (Rh), palladium (Pd), osmium (Os), iridium (Ir), platinum (Pt), or a combination thereof. In some embodiments, the PGM(s) of the alloy may be selected to be relatively less expensive than relatively more expensive PGM(s). For example, ruthenium (Ru)—having a cost of about $750 US dollars per troy ounce (per about 31 g) at present day—may be selected as the PGM (or one of the PGMs) of the alloy because Ru is generally less expensive than platinum (Pt) (costing about $1300 US dollars per troy ounce (per about 31 g) or more) and iridium (Ir) (costing about $5600 US dollars per troy ounce (per about 31 g) or more).

The at least one transition metal may be a metal within any of Group 4, Group 5, or Group 6 of the periodic table. For example, the transition metal(s) of the alloy for the anode may be titanium (Ti), zirconium (Zr), hafnium (Hf), vanadium (V), niobium (Nb), tantalum (Ta), chromium (Cr), molybdenum (Mo), tungsten (W), or a combination thereof. Of the foregoing, Ti, Zr, and Hf are Group 4 transition metals; V, Nb, and Ta are Group 5 transition metals; and Cr, Mo, and W are Group 6 transition metals.

The at least one transition metal of the alloy may, additionally or alternatively, be selected from the 3d transition metals, the 4d transition metals, and/or the 5d transition metals that are not PGM metals. The 3d transition metals are scandium (Sc), titanium (Ti), vanadium (V), chromium (Cr), manganese (Mn), Iron (Fe), cobalt (Co), nickel (Ni), copper (Cu), and zinc (Zn). Of those, Ti is a Group 4 transition metal, V is a Group 5 transition metal, and Cr is a Group 6 transition metal. Excluding PGMs, the 4d transition metals include yttrium (Y), zirconium (Zr), niobium (Nb), molybdenum (Mo), silver (Ag), and cadmium (Cd). Of those, Zr is a Group 4 transition metal, Nb is a Group 5 transition metal, and Mo is a Group 6 transition metal. Excluding PGMs, the 5d transition metals are lutetium (Lu), hafnium (Hf), tantalum (Ta), tungsten (W), rhenium (Re), gold (Au), and mercury (Hg). Of those, Hf is a Group 4 transition metal, Ta is a Group 5 transition metal, and W is a Group 6 transition metal. In some embodiments, the at least one transition metal of the alloy may be Ti, V, Cr, Zr, Nb, Mo, Hf, Ta, W, or a combination thereof. For example, in some embodiments, the TM-PGM alloy may comprise, consist substantially of, or consist of titanium-ruthenium (Ti—Ru) alloy(s), wherein Ti (a 3d transition metal in Group 4) is the selected transition metal, and Ru is the selected platinum group metal. As another example, in some embodiments, the TM-PGM alloy may comprise, consist essentially of, or consist of molybdenum-ruthenium (Mo—Ru) alloy(s), wherein Mo (a 4d transition metal in Group 6) is the selected transition metal, and Ru is the selected platinum group metal.

In further regard to embodiments employing Mo as the transition metal (or one of the transition metals) of the TM-PGM alloy, the Mo may be selected because—besides being relatively inexpensive (about $7 per troy ounce (per about 31 g))—this transition metal exhibits three desirable characteristics of effective anode materials to be used in relatively highly oxidizing atmospheres at high temperatures: e.g., a relatively high melting point, a relatively high-temperature strength, and corrosion resistance. However, pure molybdenum tends to oxidize to its oxide (MoO₃) in the presence of oxygen at high temperatures. By alloying molybdenum with a precious metal (e.g., a platinum group metal), such as ruthenium (Ru), what may otherwise be a relatively reactive anode—if the anode is formed to consist substantially of a transition metal such as the Mo—may become a relatively inert anode when the transition metal (e.g., the Mo) is alloyed with PGM(s). The TM-PGM alloy may exhibit relatively superior performance characteristics.

In some embodiments, the TM-PGM alloy of the anode may be formulated as a binary alloy, such as the aforementioned Ru—Mo alloy(s). Other TM-PGM binary alloys contemplated for embodiments of the anode of the disclosure, for example and without limitation, are other alloys of ruthenium (Ru) (e.g., as the PGM (or one of the PGMs) of the alloy) with a transition metal other than molybdenum (Mo). For example, and without limitation, in some embodiments the anode may be formed of and include such binary alloys as ruthenium-tantalum (Ru—Ta) alloy(s) (wherein the Ru is the selected PGM and the Ta is the selected transition metal), ruthenium-tungsten (Ru—W) alloy(s) (wherein the Ru is the selected PGM and the W is the selected transition metal), and/or ruthenium-titanium (Ru—Ti) alloy(s) (wherein the Ru is the selected PGM and the Ti is the selected transition metal). In some embodiments, the anode may comprise, consist substantially of one or more TM-PGM binary alloy.

In some embodiments, the TM-PGM alloy may comprise, consist substantially of one or more TM-PGM ternary alloy, with such alloy including two transition metals and one PGM or including one transition metal and two PGMs. However, the disclosure is not limited to binary alloys and ternary alloys. For example, the alloy may be formulated with four, five, or more transition metals and PGM metals, wherein at least one of the alloyed metals is a transition metal and at least one of the alloyed metals is a PGM metals.

In embodiments in which the TM-PGM alloy comprises more than two metals, the third, etc., metal may also be selected from the transition metals and PGMs, such that the TM-PGM alloy (and, in some embodiments, the anode itself) may consist substantially of or consist of transition metals and PGMs. In other embodiments in which the TM-PGM alloy comprises more than two metals, the third, etc. metal may be selected from metals outside of the transition metal and PGM categories.

The alloy of the anode may be formulated to comprise within a range of from about 50 wt. % to about 80 wt. % transition metal(s) and within a range of from about 20 wt. % to about 50 wt. % PGM(s). For example, and without limitation, the alloy (and the anode formed therefrom) may comprise about 50 wt. % transition metal(s) and about 50 wt. % PGM(s); about 70 wt. % transition metal(s) and about 30 wt. % PGM(s); or about 80 wt. % transition metal(s) and about 20 wt. % PGM(s).

At least prior to use, the TM-PGM alloy anodes may be substantially free of other chemical elements, such as oxygen (O). Therefore, the TM-PGM alloy anodes may be substantially free of oxides prior to use of the anodes. In some embodiments, at least prior to use, the TM-PGM alloy anode may also be free of metals other than the alloyed transition and platinum group metals.

With the aforementioned compositions, the TM-PGM alloy anodes disclosed herein may be substantially inert in molten salt-based electrolytes of electrochemical reduction systems. The TM-PGM alloy anodes may exhibit relatively less material deterioration than anodes formed of transition metal(s) alone, and may be significantly less expensive than anodes formed from the PGM(s) alone. The TM-PGM alloy anodes may also exhibit relatively improved material stability (less material deterioration) than if the anode included the transition metal(s) and the PGM(s) in discrete regions, rather than in alloy form.

To fabricate the TM-PGM alloy anode, an electroplating and diffusion-induced alloying process may be used, in at least some embodiments. Such an electroplating and diffusion-induced alloying process may be similar to that described in U.S. Patent Application Publication No. 2018/0209057 A1, published Jul. 28, 2018, the entire disclosure of which is hereby incorporated in its entirety herein by this reference. While the aforementioned publication describes methods and systems for electroplating of aluminum, such methods and systems may be used with the materials described herein to form the TM-PGM alloy anode in accordance with embodiments of this disclosure. Moreover, while the methods and the systems of the aforementioned publication involve bromide salt molten salt environments, embodiments of the present disclosure may make use of bromide salt(s), chloride salt(s), fluoride salt(s), iodide salt(s), or combinations of any of the foregoing. The salt(s) may be salt(s) of alkali and alkaline earth metals or combinations thereof. For example, in some embodiments, the process and systems may use a chloride salt in combination with a bromide salt, a bromide salt in combination with a fluoride salt, a combination of a bromide salt with an iodide salt, or other combinations of molten halide salts.

Pursuant to an electroplating and diffusion-induced alloying process, a substrate may be provided comprising a first metal (or first metals), and a second metal (or second metals) are electroplated onto the first metal(s) substrate. In some embodiments, the first metal(s) may be some or all of the transition metal(s) of the alloy and the second metal(s) may be some or all of the platinum group metal(s) of the alloy. In other embodiments, the first metal(s) may be some or all of the platinum group metal(s) of the alloy and the second metal(s) may be some or all of the transition group metal(s). Accordingly, an intermediate structure is formed with the second metal(s) coated upon the substrate of the first metal(s). The intermediate structure may be heated to diffuse one or both of the first and second metal(s) into the other, forming one or more alloys of the first and second metals. Accordingly, the alloy(s) is(are) formed by diffusion inducement.

For example, the alloying of the TM-PGM may be performed by an electroplating process in a molten salt-based media. A first metal (or first metals) of the TM and the PGM (e.g., either the TM (any one or more of Ti, Mo, Nb, Ta, etc.) or the PGM (any one or more of Ir, Ru, etc.)) may be included in a cathode used in a molten salt electroplating cell. A second metal (or second metals) of the TM and the PGM (e.g., the other of the TM and the PGM) may be present in a compound form (e.g., a halide) in the electrolyte of the cell. Upon the passage of an electric current, the second-metal(s) compound undergoes dissociation, and the metallic portion (of the second metal(s)) plates on the cathode (e.g., on the first metal(s)). The time, temperature, and electrolyte composition may be adjusted to obtain a desired surface thickness of the second metal(s) on the first metal(s). Subsequent annealing of the plated cathode structure may allow the surface metal (the second metal(s)) to diffuse through the surface and alloy with the base/substrate metal (the first metal(s)) to form the TM-PGM alloy in situ. A chloride, bromide, and/or fluoride salt electrochemical cell may be employed in this process. Such a fabrication process may utilize a manufacturing temperature (e.g., less than about 1000° C.) that is significantly lower than the temperature(s) involved in the relatively more energy intensive co-melting processes available for alloying metals. In some such electroplating and diffusion-induced alloying processes, the temperature used during the electroplating may be less than about 500° C.

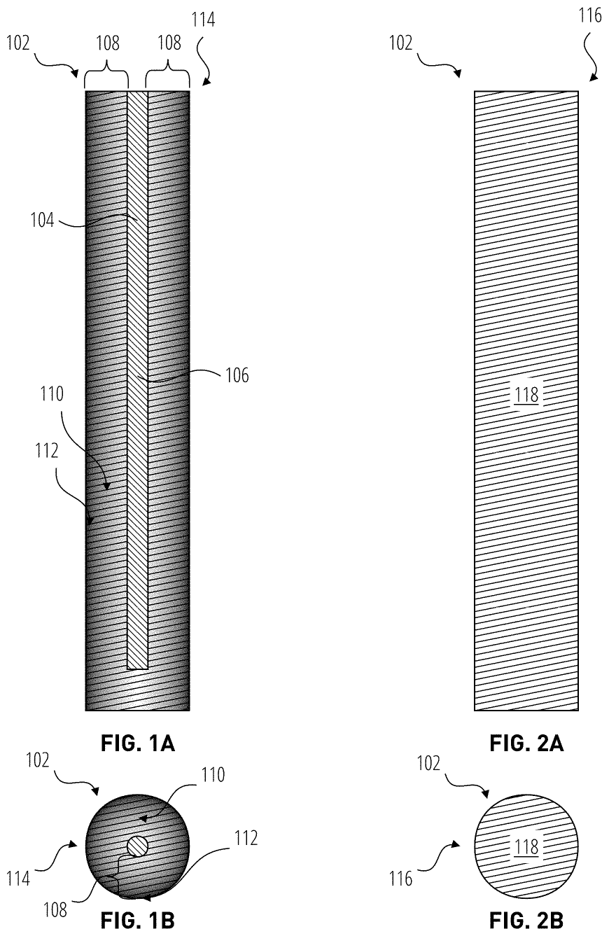

With reference to FIG. 1A and FIG. 1B, schematically illustrated is a TM-PGM alloy anode 102 that may be formed by the aforementioned electroplating and diffusion-induced alloying process. The TM-PGM alloy anode 102 includes a core 104 of the first metal(s) 106. The core 104 may consist of or consist substantially of the first metal(s) 106. At least laterally surrounding the core 104 is an alloy gradient 108 region, which may include a gradient alloy composition of the first and second metals, such that—at varying radial distances from the core 104—the alloy composition may also vary. Thus, at one radial area 110, the first and second metals may exhibit a first alloy form, while at a different radial area 112, the first and second metals may exhibit a second alloy form. The first alloy form and the second alloy form may differ in relative amounts of the first and second metals. Additionally or alternatively, the oxidation states of the first metal and/or second metal in the first alloy form may differ from the oxidation states of the first metal and/or second metal, respectively, in the second alloy form. The resulting TM-PGM alloy anode 102 may be characterized, herein, as a gradient TM-PGM alloy anode 114. Such an approach favors the formation of solid solution types of alloy anodes without forming any or significant amounts of brittle intermetallic alloy phase(s). Forming brittle intermetallic alloy phase(s) may be detrimental to obtaining desired performance characteristics of the alloy anodes.

For example, the first metal(s) 106 may be formed from one or more transition metals, such as molybdenum (Mo). A rod of the Mo first metal(s) 106 may be used in an electrochemical cell in which the electrolyte comprises at least one halide (e.g., chloride, bromide, fluoride, iodide) compound of the second metal(s) formed from one or more platinum group metals, such as ruthenium (Ru). Accordingly, the electrolyte may comprise ruthenium chloride, ruthenium bromide, ruthenium fluoride, and/or ruthenium iodide as the functional electrolyte along with alkali/alkaline earth metal halide salts as a supporting electrolyte. In operating the electrochemical cell, the Ru is made to deposit on the Mo rod and subsequent annealing may cause the Ru and Mo to diffuse into one another and alloy in various compositions (e.g., chemical compositions and/or oxidation states) at various radial distances. Therefore, the alloy gradient 108 region of the gradient TM-PGM alloy anode 114 may include one Mo—Ru alloy (e.g., an alloy of about 50 wt. % Mo and about 50 wt. % Ru) at the radial area 110 but another Mo—Ru alloy (e.g., an alloy of about 30 wt. % Mo and about 70 wt. % Ru) at the radial area 112 that is further from the Mo core 104. In some embodiments, in addition to or other than the aforementioned Mo—Ru alloys, the alloys may comprise about 90 wt. % Mo and about 10 wt. % Ru, about 80 wt. % Mo and about 20 wt. % Ru, or other relative weight percentages of the Mo and Ru.

In the gradient TM-PGM alloy anode 114, the inclusion of different radial rings of varying alloy compositions may enhance the compositional structure of the TM-PGM alloy anode 102 and facilitate its use in oxide reduction processes. The somewhat layered arrangement of the alloys of varying compositions may inhibit oxygen atoms from diffusing into the core 104 where such chemical species may cause embrittlement (followed by oxidation) of the first metal(s) 106. Accordingly, the TM-PGM alloy anode 102 formed to include the alloy gradient 108 of various alloy compositions may inhibit deterioration of the TM-PGM alloy anode 102 and facilitate a longer life of the TM-PGM alloy anode 102.

With reference to FIG. 2A and FIG. 2B, in other embodiments, the TM-PGM alloy anode 102 may be formed—either by the above-described electroplating process or by other processes described herein or otherwise known in the art—to be substantially homogenous in its alloy composition, forming a TM-PGM alloy anode 102 characterized herein as a homogenous TM-PGM alloy anode 116. Like the gradient TM-PGM alloy anode 114 (FIG. 1A, FIG. 1B), the homogenous TM-PGM alloy anode 116 may be generally cylindrical. However, the composition of the TM-PGM alloy may be substantially consistent throughout at least that portion of the homogenous TM-PGM alloy anode 116 that is to be exposed to an electrolyte during the electrochemical oxidation. Therefore, the homogenous TM-PGM alloy anode 116 may comprise, consist substantially of, or consist of a homogenous alloy 118 across the diameter of the homogenous TM-PGM alloy anode 116.

In other embodiments, the homogenous TM-PGM alloy anode 116 may be formed by conventional alloying methods such as, for example and without limitation, mixing and compacting powders of the transition metal(s) and the platinum group metal(s) in the desired ratio and melting and/or sintering (e.g., spark plasma sintering) the mixture to form an alloyed structure. Because of the difference in densities of the transition group metal(s) and the platinum group metal(s), a relatively long annealing process, post-melting and/or sintering, may be performed to homogenize the alloy material in the alloyed structure to inhibit segregated phases of one or more of the metals from remaining in the structure. Accordingly, forming the alloy anode by such conventional melt/sinter processes may include application of high temperatures and high vacuum environments to form the homogenous TM-PGM alloy anode 116 with the substantially consistent homogenous alloy 118 composition.

Conventional methods for forming an anode with a substantially consistent alloy composition (e.g., methods that may be incorporated to form the homogeneous TM-PGM alloy anode 116 of FIG. 2A and FIG. 2B) tend to include application of relatively high temperatures (e.g., melting temperatures of about 2000° C. or more) and high vacuum environments. In contrast, the electroplating and diffusion-induced alloying process described above to form the gradient TM-PGM alloy anode 114 of FIG. 1A and FIG. 1B may be relatively low-temperature processes (e.g., maximum temperatures within a range from about 250° C. to about 800° C.). Therefore, the electroplating and diffusion-induced alloying process may be relatively less costly to perform.

While the figures of FIG. 1B and FIG. 2B illustrate the TM-PGM alloy anodes 102 as substantially cylindrical structures (e.g., “rods”), in other embodiments the TM-PGM alloy anodes 102 may be formed in other shapes, such as a plate shape, wherein the cross-sectional illustrates of FIG. 1A and FIG. 2A may each represent an elevational cross-section of a substantially planar block-like or plate-like structure. Accordingly, the TM-PGM alloy anode 102 may be a substantially solid structure (e.g., substantially nonporous) formed of and including the TM-PGM alloy(s) of embodiments of the disclosure.

Whether formed by the electroplating and diffusion-induced alloying process or by other methods, the resulting TM-PGM alloy anode 102 may be substantially free of, e.g., oxygen, upon completion of fabrication and prior to use. In some embodiments, at least prior to use, the TM-PGM alloy anode 102 may also be free of metals other than the alloyed transition and platinum group metals.

Accordingly, disclosed is an anode for an electrochemical reduction system. The anode comprises a rod or plate comprising at least one alloy of (1) at least one transition metal; and (2) at least one platinum group metal.

Also, accordingly, disclosed is a method of forming an anode for an electrochemical reduction system. The method comprises forming a rod or plate comprising at least one alloy. The method also includes forming the at least one alloy of (1) at least one transition metal and (2) at least one platinum group metal.

The TM-PGM alloy anode 102—whether formed as the gradient TM-PGM alloy anode 114 of FIG. 1A and FIG. 1B, as the homogenous TM-PGM alloy anode 116 of FIG. 2A and FIG. 2B, or with some other structure that comprises, consists substantially of, or consists of the TM-PGM alloy—may be used within an electrochemical system with a molten salt electrolyte for the electrochemical reduction of metal oxides to their constituent metal(s).

Electrochemical processes may be used to produce metals and alloys from a variety of intermediates of the constituent metals. These metal intermediates or compounds include, primarily, halides and oxides. These compounds may be dissolved in an appropriate electrolyte, and, when an electric current is applied between a cathode and anode, the compounds undergo thermal decomposition. The metallic part of the compound deposits on the cathode and is subsequently harvested from the electrochemical cell. The non-metallic part of the compound evolves on the anode surface as a gaseous species. This electrochemical process is known in the art as “electrowinning.” The success of an electrowinning process may depend on a number of parameters, such as the nature of the electrodes (e.g., the anode, the cathode), the solubility of the metal compound in the electrolyte, operating temperature, and current density.

Electrochemical reduction of metal oxides into their constituent metals may be performed two ways: dissolution of the oxide in an electrolyte and direct (cathodic) polarization of the oxide against a suitable anode material. In the latter process, the oxide—unlike in the previous process in which the oxide is dissolved in an electrolyte—forms the cathode of the electrochemical cell. The anode closes the electrical circuit. When a current flows between the anode and the cathode, the oxygen ions present in the cathode undergo ionization by capturing electrons coming from the external circuit. Under a polarized condition, the oxygen ions enter the electrolyte, travel to the anode, and discharge their electrons on the anode surface. Depending on the nature of the anode material, oxygen ions are liberated either as molecular oxygen or as oxides of carbon, such as carbon dioxide, carbon monoxide, or both. With a non-reactive anode (i.e., an “inert” anode), the anode gas is oxygen. Use of an inert anode—such as the TM-PGM alloy anodes of embodiments of the disclosure—may avoid generation of obnoxious gases and may facilitate formation of relatively-pure products with relatively-less burden on the environment.

The molten salt media as the electrolytes of such electrochemical reduction processes may comprise, for example and without limitation, halide melts, such as halide-based molten salts (e.g., chloride-based melts, such as molten chloride salt(s) (e.g., calcium chloride melts, lithium chloride based melts); bromide-based melts, such as molten bromide salt(s) (e.g., lithium-bromide-potassium-bromide molten salt); fluoride-based melts, such as molten fluoride salt(s); iodide-based melts, such as molten iodide salt(s); or combinations (e.g., mixtures) of any of the foregoing). Therefore, the TM-PGM alloy anodes of embodiments of the disclosure may be configured for use in the commercial production of electrolytic grade metals or metal alloys that find widespread applications in many modern technologies including the clean energy sector. The anodes of embodiments of the disclosure may be beneficial and configured for use in industries such as corrosion, equipment manufacturing, and metals industries (both primary as well as secondary).

The TM-PGM alloy anodes may also be useful in the electrochemical reduction of used (e.g., oxide) nuclear fuels. For example, because the TM-PGM alloy anodes may comprise components that are, themselves, common fission products (e.g., molybdenum, ruthenium, rhenium, palladium, and iridium are important fission products) the use of the TM-PGM alloy(s) as inert anodes, in an oxide reduction electrochemical cell, may prove to be advantageous as compared to other monolithic (e.g., non-alloyed) anodes formed from platinum group metals. The effectiveness of the TM-PGM alloy anodes may further be enhanced by combining other metals from either or both the groups (e.g., the platinum group and the transition metal group).

In some embodiments, the anode (e.g., a counter electrode) comprises a substrate comprising a different material than the at least one platinum group metal or the at least one transition metal and the TM-PGM alloy(s) is(are) formed around the substrate.

The counter electrode may be substantially inert in the electrochemical cell. The counter electrode may resist attack from the molten salt electrolytes, which may be corrosive at high temperatures (e.g., greater than about 600° C., greater than about 800° C., etc.) under oxidizing conditions. The counter electrode may exhibit good electrical conductivity suitable for operation in the electrochemical cell. Accordingly, the material of the counter electrode may not be consumed during the electrochemical reduction reaction (e.g., direct oxide reduction) and the counter electrode may not need to be replaced as in conventional electrochemical cells.

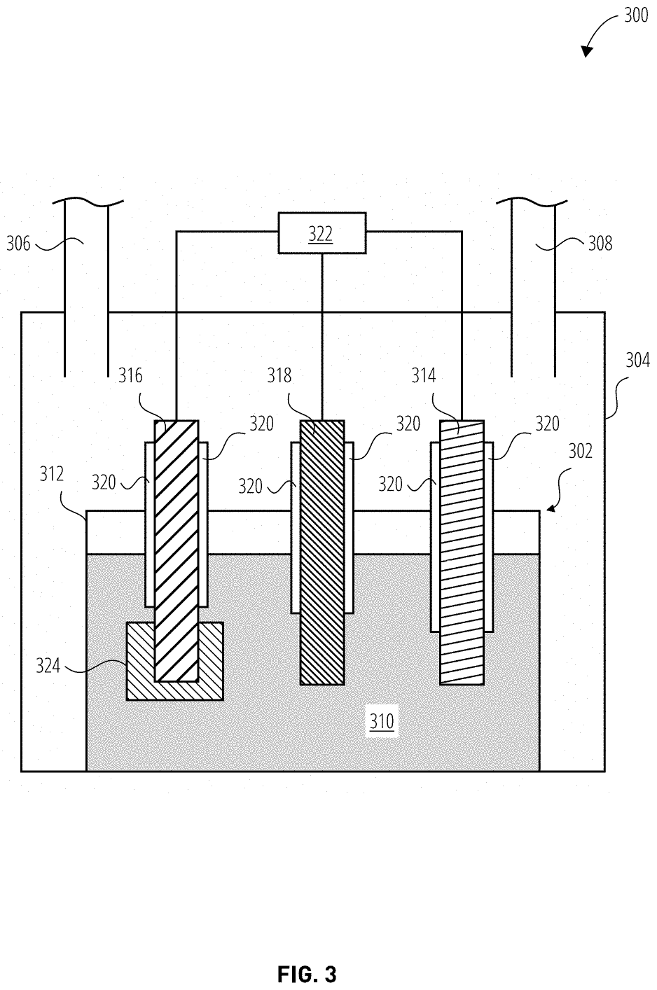

With reference to FIG. 3, illustrated as a simplified schematic is a system 300, in accordance with embodiments of the disclosure, including an electrochemical cell 302 for reducing (e.g., electrochemically reducing) one or more metal oxides to form one or more metals. The electrochemical cell 302 may be configured as a so-called “direct oxide reduction” (DOR) electrochemical cell. In other words, the electrochemical cell 302 may be configured to reduce one or more oxides.

The electrochemical cell 302 may be contained within a gas-tight enclosure 304, which may include an inlet 306 and an outlet 308. The inlet 306 is configured for providing, for example, a gas to the enclosure 304 for maintaining a gas pressure within the enclosure 304. Gases may be removed from the enclosure 304 via the outlet 308. In some embodiments, the gas comprises an inert gas, such as argon, helium, or a combination thereof. The enclosure 304 may include a furnace or other heating element for heating or maintaining a temperature of a molten salt electrolyte 310 in the electrochemical cell 302. Although FIG. 3 illustrates that the enclosure 304 includes the inlet 306 and the outlet 308, the disclosure is not so limited. In other embodiments, the enclosure 304 may be configured as a so-called “glove box” wherein the enclosure 304 is not configured with an inlet 306 and an outlet 308 for gas flow into and out of the electrochemical cell 302 during operation thereof.

The electrochemical cell 302 may include a crucible 312 comprising a metal, glassy carbon, ceramic, a metal alloy, or another material. In some embodiments, the crucible 312 comprises a non-metallic material, such as alumina (Al₂O₃), magnesia (MgO), glass carbon, graphite, boron nitride, another material, or combinations thereof. In other embodiments, the crucible 312 comprises a metal or metal alloy, such as, for example, nickel, molybdenum, tantalum, stainless steel, alloys of nickel and copper, alloys of nickel, chromium, iron, and molybdenum, alloys of nickel, iron, and molybdenum, and combinations thereof.

The molten salt electrolyte 310 may be disposed in the crucible 312. The electrochemical cell 302 may further include at least one counter electrode 314 (which may also be referred to as an anode) and at least one working electrode 316 (which may also be referred to as a cathode). In some embodiments, the electrochemical cell 302 further includes a reference electrode 318 configured for monitoring a potential in the electrochemical cell 302. In some embodiments, a sheath 320 is disposed around at least a portion of one or more of the counter electrode 314, the working electrode 316, and the reference electrode 318. The sheath 320 may be configured to provide electrical insulation between the respective electrodes and the crucible 312. In some embodiments, the sheath 320 comprises alumina (e.g., an alumina tube), magnesia, or a combination thereof.

The counter electrode 314 may comprise, consist substantially of, or consist of any of the above-described TM-PGM alloy materials. In some embodiments, the counter electrode 314 may be structured and formed as the gradient TM-PGM alloy anode 114 of FIG. 1A and FIG. 1B. In other embodiments, the counter electrode 314 may be structured and formed as the homogenous TM-PGM alloy anode 116 of FIG. 2A and FIG. 2B.

The reference electrode 318 may be in electrical communication with the counter electrode 314 and the working electrode 316 and may be configured to monitor the potential difference between the counter electrode 314 and the working electrode 316. Accordingly, the reference electrode 318 may be configured to monitor the cell potential of the electrochemical cell 302.

The reference electrode 318 may be configured as a so-called “true reference electrode” or as a so-called “pseudo-reference electrode.” The reference electrode 318 may be formed of and include nickel, nickel/nickel oxide, glassy carbon (GC), silver/silver chloride, one or more platinum group metals, one or more precious metals (e.g., gold), or combinations thereof. In some embodiments, the reference electrode 318 comprises glassy carbon. In other embodiments, the reference electrode 318 comprises nickel, nickel oxide, or a combination thereof. In yet other embodiments, the reference electrode 318 comprises silver/silver chloride.

A potentiostat-galvanostat 322 may be electrically coupled to each of the counter electrode 314, the working electrode 316, and the reference electrode 318. The potentiostat-galvanostat 322 may be configured to measure and/or provide an electric potential between the working electrode 316 and the reference electrode 318 while the current flows between the counter electrode 314 and the working electrode 316. The difference between the electric potential of the counter electrode 314 and the electric potential of the working electrode 316 may be referred to as the cell potential of the electrochemical cell 302.

The system 300 may be configured to reduce one or more metal oxides to a substantially pure metal (e.g., the metal in a substantially unoxidized state) or a metal alloy. In some such embodiments, the working electrode 316 includes at least one oxide (e.g., at least one metal oxide) to be reduced in the electrochemical cell 302.

The working electrode 316 may be in electrical communication with a vessel (e.g., a basket 324) configured to carry one or more metals to be reduced in the electrochemical cell 302. The basket 324 may comprise nickel, cobalt, iron, molybdenum, stainless steel, alloys of nickel and copper, alloys of nickel, chromium, iron, and molybdenum, alloys of nickel, iron, and molybdenum, another material, or combinations thereof. In some embodiments, the basket 324 comprises nickel. In other embodiments, the electrochemical cell 302 does not include the basket 324 and the working electrode 316 comprises the metal oxide or a combination of metal oxides to be electrolytically reduced in the electrochemical cell 302. Stated another way, in some embodiments, the working electrode 316 comprises one or more metal oxides that are reduced to a metal (e.g., a substantially pure metal or a metal alloy) in the electrochemical cell 302. In some embodiments, the working electrode 316 consists essentially of the metal oxide, which may comprise one or more metals to be reduced.

At least one of the working electrodes 316 and the metal in the basket 324 that is supported by the working electrode 316 may comprise a metal oxide. The metal oxide may comprise at least one transition metal oxide (such as a refractory metal oxide (e.g., titanium oxide (TiO), titanium dioxide (TiO₂), zirconium oxide (ZrO₂), hafnium oxide (HfO₂), vanadium oxide (V₂O₅), niobium oxide (NbO₂, Nb₂O₅), tantalum pentoxide (Ta₂O₅), chromium oxide (CrO, Cr₂O₃, etc.), manganese oxide (MnO), nickel oxide (NiO, Ni₂O₃), molybdenum oxide (MoO₃), tungsten oxide (WO₃, WO₂), ruthenium oxide (RuO₂), osmium oxide (OsO₂, OsO₄), rhodium oxide (Rh₂O₃), iridium oxide (IrO₂)), iron oxide (Fe₂O₃, Fe₃O₄, etc.), cobalt oxide (CoO, Co₂O₃, Co₃O₄)), non-metal oxides (e.g., silicon dioxide (SiO₂), boric oxide (B₂O₃)), a lanthanide oxide (e.g., lanthanum oxide (La₂O₃), cerium oxide (CeO₂), neodymium oxide (Nd₂O₃), samarium oxide (Sm₂O₃), dysprosium oxide (Dy₂O₃), another oxide of a lanthanide element), an actinide oxide (e.g., actinium oxide (Ac₂O₃), thorium oxide (ThO₂), uranium oxide (e.g., UO₂), an oxide of another actinide element), or combinations thereof. The metal oxide in or supported by the working electrode 316 may be selected from the group consisting of oxides of titanium (Ti), zirconium (Zr), hafnium (Hf), vanadium (V), niobium (Nb), tantalum (Ta), chromium (Cr), manganese (Mn), nickel (Ni), molybdenum (Mo), tungsten (W), ruthenium (Ru), osmium (Os), rhodium (Rh), iridium (Ir), iron (Fe), cobalt (Co), silicon (Si), boron (B), lanthanum (La), cerium (Ce), neodymium (Nd), samarium (Sm), dysprosium (Dy), actinium (Ac), thorium (Th), uranium (U), and combinations thereof.

In some embodiments the working electrode 316 may consist substantially of or consist of a single oxide (e.g., any of the aforementioned oxides). In other embodiments, the working electrode 316 may comprise, consist substantially of, or consist of a mixture of oxides, such as a mixture of a titanium oxide and a tantalum oxide; a mixture of a hafnium oxide and a titanium oxide; or a mixture of neodymium oxide (Nd₂O₃), boric oxide (B₂O₃), and iron oxide (Fe₂O₃).

In some embodiments, the metal oxide comprises an unirradiated nuclear fuel, such as enriched/depleted uranium oxide. In other embodiments, the metal oxide comprises a spent nuclear fuel, such as spent uranium oxide (e.g., UO₂, U₃O₈, or a combination thereof). In some embodiments, the metal oxide comprises an oxide of more than one metal. Reduction of such oxides may form a metal alloy comprising the constituent metals of the metal oxides. In some embodiments, the metal oxide is disposed in the basket 324 and in electrical communication with the working electrode 316. In other embodiments, the working electrode 316 consists essentially of the metal oxide. In either such embodiments, the working electrode 316 comprises or supports the metal oxide.

The molten salt electrolyte 310 may include a material formulated and configured to facilitate reduction of the metal oxides. In some embodiments, the molten salt electrolyte 310 comprises an alkali halide salt, an alkaline earth metal halide salt, an alkali oxide, an alkaline earth metal oxide, or combinations thereof. By way of nonlimiting example, the molten salt electrolyte 310 may include lithium chloride (LiCl), lithium oxide (Li₂O), sodium chloride (NaCl), calcium chloride (CaCl₂), calcium oxide (CaO), lithium bromide (LiBr), potassium bromide (KBr), cesium bromide (CsBr), calcium bromide (CaBr₂), potassium chloride (KCl), potassium bromide (KBr), strontium chloride (SrCl₂), strontium bromide (SrBr₂), or combinations thereof. In some embodiments, the molten salt electrolyte 310 comprises a eutectic mixture of sodium chloride and potassium chloride, and may further include calcium oxide. In some embodiments, the molten salt electrolyte 310 may comprise, consist substantially of, or consist of mixtures including chloride-based melt(s) (e.g., calcium-chloride-sodium-chloride (CaCl₂/NaCl), lithium-chloride-lithium-oxide (LiCl/Li₂O), calcium-chloride-calcium-oxide (CaCl₂/CaO)), bromide-based melt(s) (e.g., lithium-bromide-lithium-oxide (LiBr/Li₂O), calcium-bromide-calcium-oxide (CaBr₂/CaO), sodium-bromide-calcium-bromide (NaBr/CaBr₂)), or any combination of the foregoing.

In some embodiments, the molten salt electrolyte 310 comprises lithium chloride and lithium oxide (LiCl—Li₂O). In some such embodiments, the lithium oxide constitutes between about 1.0 weight percent (wt. %) and about 5.0 weight percent of the molten salt electrolyte 310, such as between about 1.0 weight percent and about 2.0 weight percent, between about 2.0 weight percent and about 3.0 weight percent, or between about 3.0 weight percent and about 5.0 weight percent of the molten salt electrolyte 310. The lithium chloride may constitute a remainder of the molten salt electrolyte 310. In some embodiments, the lithium oxide constitutes about 1.0 weight percent of the molten salt electrolyte 310. In other embodiments, the lithium oxide constitutes about 5.0 weight percent of the molten salt electrolyte 310. In some embodiments, the molten salt electrolyte 310 comprises lithium chloride and lithium oxide and the metal oxide comprises uranium oxide. In other embodiments, the metal oxide comprises one or more of manganese oxide, nickel oxide, and titanium monoxide.

In other embodiments, the molten salt electrolyte 310 comprises calcium chloride and calcium oxide (CaCl₂—CaO). In some such embodiments, the calcium oxide constitutes between about 1.0 weight percent and about 5.0 weight percent of the molten salt electrolyte 310, such as between about 1.0 weight percent and about 2.0 weight percent, between about 2.0 weight percent and about 3.0 weight percent, or between about 3.0 weight percent and about 5.0 weight percent of the molten salt electrolyte 310. The calcium chloride may constitute a remainder of the molten salt electrolyte 310. In some embodiments, the calcium oxide constitutes about 1.0 weight percent of the molten salt electrolyte 310. In other embodiments, the calcium oxide constitutes about 5.0 weight percent of the molten salt electrolyte 310. In some embodiments, the molten salt electrolyte 310 comprises calcium chloride and calcium oxide and the metal oxide comprises tantalum pentoxide, titanium oxide, a lanthanide oxide, an actinide oxide, or combinations thereof.

The molten salt electrolyte 310 may be maintained at a temperature such that the molten salt electrolyte 310 remains in a molten state. In other words, the temperature of the molten salt electrolyte 310 may be maintained at or above a melting temperature of the molten salt electrolyte 310. By way of nonlimiting example, where the molten salt electrolyte 310 comprises lithium chloride and lithium oxide, the temperature of the molten salt electrolyte 310 may be between about 650° C. and about 700° C. Where the molten salt electrolyte 310 comprises calcium chloride and calcium oxide, the temperature of the molten salt electrolyte 310 may be between about 800° C. and about 950° C. Where the molten salt electrolyte 310 comprises sodium chloride and calcium chloride, the temperature thereof may be maintained between about 550° C. and about 950° C. However, the disclosure is not so limited and the temperature of the molten salt electrolyte 310 may be different than those described above.

The molten salt electrolyte 310 may facilitate reduction of the metal oxide. In some embodiments, the metal oxide may be reduced at the working electrode 316, according to Equation (1) below:

M_{y}Oₓ(s)+z e⁻→yM+z/xO²⁻ (1).

wherein “M” is a metal (e.g., a transition metal, a lanthanide, an actinide, etc.), “M_{y}Oₓ” is the metal oxide, “x” is the stoichiometric amount of oxygen for the particular metal oxide, “y” is the stoichiometric amount of the metal in the metal oxide, and “z” is the stoichiometric amount of electrons for balancing the chemical reaction. The electrons are provided in the electrochemical cell 302 by provision of current to the working electrode 316, such as through the potentiostat-galvanostat 322.

The oxide ions generated at the working electrode 316 may be transported from the working electrode 316 to the counter electrode 314 responsive to exposure to the applied electrical field (i.e., a polarization between the counter electrode 314 and the working electrode 316, provided by the potentiostat-galvanostat 322). The oxide ions may be oxidized at the counter electrode 314 according to Equation (2) below:

2O²⁻→O₂(g)+4e⁻ (2).

The oxygen ions deposit the electrons on the surface of the counter electrode 314 and subsequently get evolved as the oxygen gas at the counter electrode 314. The electrons return to the working electrode 316 via the external circuit of the potentiostat-galvanostat 322 to ionize the oxygen present in the metal oxide.

In use and operation, the metal oxide may be disposed in the electrochemical cell 302 and in contact with the molten salt electrolyte 310. An electric potential may be applied between the counter electrode 314 and the working electrode 316, providing a polarization field and a driving force for moving oxide ions, from the working electrode 316, via the electrolyte, to the counter electrode 314, facilitating reduction of the metal oxide at the working electrode 316.

As described above, upon depositing the electrons at the counter electrode 314, the oxide anions may evolve as oxygen gas at the counter electrode 314. The counter electrode 314—being formulated to comprise, consist essentially of, or consist of the TM-PGM alloy(s) as described above (e.g., as the gradient TM-PGM alloy anode 114 of FIG. 1A and FIG. 1B, as the homogenous TM-PGM alloy anode 116 of FIG. 2A and FIG. 2B, or some other anode structure)—is formulated and configured to be substantially inert to the molten salt electrolytes 310, the oxide ions, and the oxygen gas. In addition, the TM-PGM alloy(s) of the counter electrode 314 may be substantially inert to gases that may evolve from the metal oxide. For example, where the metal oxide comprises a spent nuclear fuel, the metal oxide may include fission byproducts, such as selenium, tellurium, or iodine. The TM-PGM alloy(s) of the counter electrode 314 may be substantially inert to such gases. Accordingly, the counter electrode 314 includes a TM-PGM alloy material formulated and configured to be substantially inert in the electrochemical cell 302 at operating conditions thereof.

Accordingly, disclosed is an electrochemical reduction system. The system comprises a counter electrode comprising at least one alloy of at least one platinum group metal and at least one transition metal. The electrochemical reduction system also comprises an electrolyte comprising a molten salt.

### EXAMPLES

Laboratory scale experiments have been performed using both monolithic metal (ruthenium) and ruthenium-based alloy (ruthenium-molybdenum and ruthenium-titanium) rods as the anode materials to carry out electrochemical reduction of two oxides (tantalum pentoxide and titanium monoxide) in calcium chloride melts. These experiments ranged up to a duration of twenty-four hours (24 hrs.) in each case. Conditions were selected to expose the electrodes to in situ generated calcium metal and oxygen in the operating temperature range of 800° C. to 950° C. The anodes were removed from the electrochemical test runs to examine their physical conditions. No perceptible thinning and/or mechanical degradation in the anode materials were observed. Subsequently, both anodes were tested in bromide melts. As with the chloride melts, the bromide melts did not degrade these anode materials, even in the presence of in situ generated bromine gas.

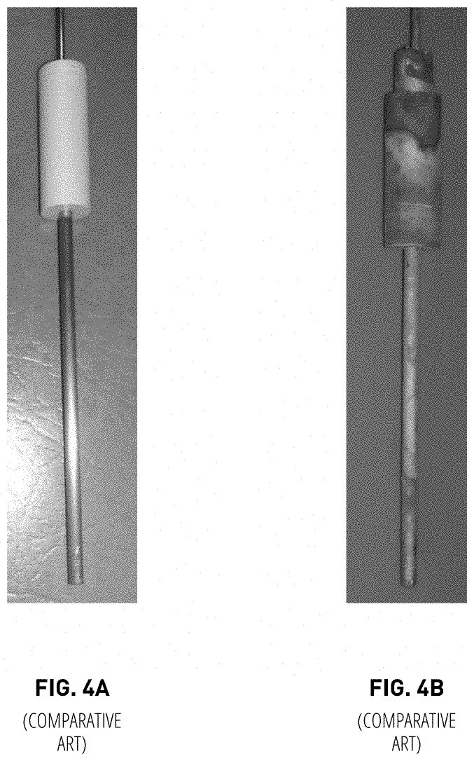

With reference to FIG. 4A and FIG. 4B, pictured are a monolithic ruthenium (3 mm dia. and 100 mm long) anode both before testing (FIG. 4A) and after testing (FIG. 4B) in a calcium-chloride-calcium-oxide melt during the electrochemical reduction of Ta₂O₅ for a duration of 20 hours and at a temperature of 900° C. As the photos indicate, the monolithic ruthenium anode—an anode form substantially of only a platinum group metal—exhibited substantially no thinning (e.g., substantially no material attrition) due to being used in the electrochemical reduction process.

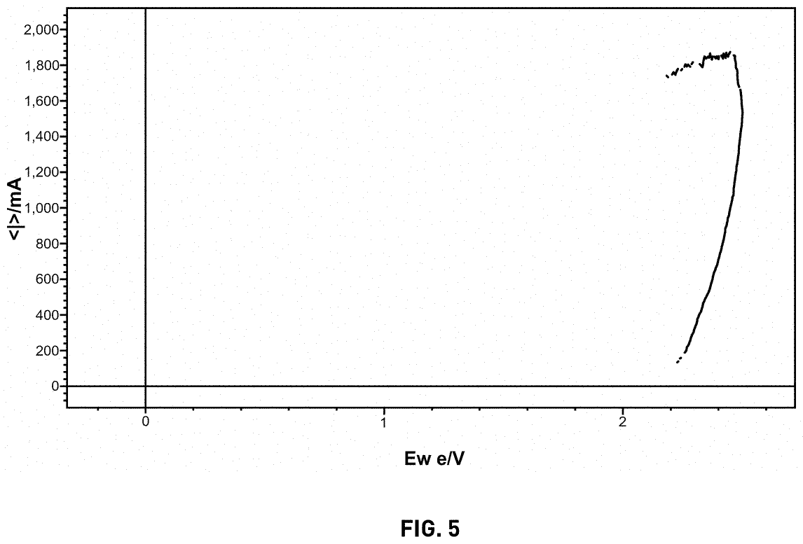

FIG. 5 is a cyclic voltammogram showing the evolution of bromine gas during the electrochemical decomposition of LiBr in a eutectic LiBr—KBr electrolyte at 400° C. Both a ruthenium electrode (FIG. 4A and FIG. 4B) (e.g., a PGM-only anode) and a ruthenium-molybdenum (Ru—Mo) alloy electrode (e.g., a TM-PGM alloy anode) were exposed to bromine gas. No thinning (e.g., material attrition) was observed with either electrode. Bromine evolution did not take place up to about 2.1V (in the anodic direction), which indicates both anodes were robust in the bromide melt. Accordingly, the TM-PGM alloy anode (the Ru—Mo alloy electrode) exhibited substantially the same material robustness (e.g., lack of material attrition) as the PGM-only anode (the ruthenium electrode).

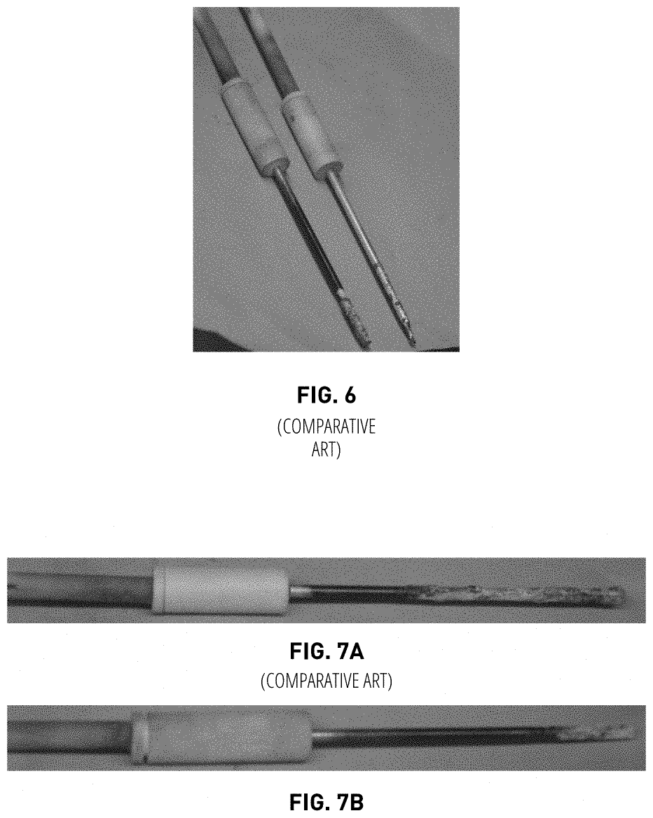

The photograph of FIG. 6 demonstrated the performance characteristics of ruthenium (left) and platinum (right) anodes (e.g., both PGM-only anodes) after use in a calcium-chloride-calcium-oxide melt during the electrochemical reduction of tantalum pentoxide at 900° C. While the platinum anode underwent thinning, no thinning was observed in the ruthenium anode. Therefore, platinum, alone, proved not to be a good anode material.

The photographs of FIG. 7A and FIG. 7B illustrate the performance characteristics of a ruthenium anode (FIG. 7A) (e.g., a PGM-only anode) and a ruthenium-molybdenum alloy anode (FIG. 7B) (e.g., a TM-PGM alloy anode) after use in a calcium-chloride-calcium-oxide melt during the electrochemical reduction of tantalum pentoxide at 900° C. Both anodes showed no signs of thinning or mechanical degradation. Therefore, the ruthenium-molybdenum alloy anode (FIG. 7B), i.e., a TM-PGM alloy anode, exhibited at least comparable performance characteristics to a monolithic ruthenium anode (FIG. 7A), i.e., a PGM-only anode.

On the basis of the aforementioned results, a TM-PGM alloy anode showed promise for use as an effective anode material in halide melts (molten bromide and chloride salts), with performance characteristics comparable to those of monolithic, PGM-only anodes. It is contemplated that the TM-PGM alloy anodes may exhibit a material attrition rate well below about 10 mm/year (as the tests with ruthenium-molybdenum and ruthenium-titanium have conformed to such a standard), which may be well below the target attrition rates, which is about 15 mm/year to about 20 mm/year for anode material suitability, as established by the aluminum industry.

As an example involving use of a TM-PGM alloy anode in an electrochemical reduction of a metal oxide, 10 grams of Ta₂O₅ (e.g., a metal oxide) was sintered at 950° C. in air for one hour and, in pelletized form, was cathodically polarized in a pool of anhydrous and high-purity molten calcium chloride-1 wt. % calcium oxide electrolyte against a binary ruthenium-molybdenum (50 wt. % Mo, 50 wt. % Ru) anode (i.e., a TM-PGM alloy anode) for a duration of twenty-four hours at 900° C. A glassy carbon rode (3 mm diameter, 100 mm length) was used as a reference electrode. The furnace was switched off after 24 hours, and the electrodes (both cathode and anode) were removed from the electrochemical cell. The cathode had converted from pure white to greyish-black with adhered (solidified) salt on its surface. The reduced pellet, upon immersion in 100 mm water, disintegrated into fine powders. The powders were subsequently washed with ethanol and acetone and oven-dried in a glove box at a temperature of 100° C. for five hours. The dried powder was evaluated and characterized to be 99.5% pure tantalum metal. The anode was provided a similar cleaning treatment. Upon examination, the portion of the anode surface (that remained immersed in molten salt for the entire duration) was observed to have a roughened surface without any thinning, formation of pits, or necking. Accordingly, in the electrochemical reduction of tantalum oxide to high-purity tantalum metal, the TM-PGM alloy anode exhibited material robustness.

As a further example involving use of a TM-PGM alloy anode in an electrochemical reduction of a metal oxide, 20 grams of TiO (e.g., a metal oxide) (in the form of irregular sized 3 mm to 5 mm chunks) was placed in a perforated nickel basket. The basket containing the oxide was lowered into a molten pool of calcium chloride-1 wt. % calcium oxide electrolyte at 900° C. The polarization experiment was performed for a duration of thirty hours against a ruthenium-titanium (50 wt. % ruthenium, 50 wt. % titanium) alloy anode (i.e., a TM-PGM alloy anode). The basket was subsequently removed from the electrochemical cell, and the reduced chunks were cleaned with water, action, and ethanol. An oxygen analysis performed on the chunks collected from different zones showed the oxygen composition values to be in the range from 1 wt. % to 3 wt. % from an initial value of 25 wt. % (in the unreduced TiO). The anode had a rough surface on the portion that remained in the molten salt without any material loss. Accordingly, in the electrochemical reduction of titanium oxide to high-purity titanium metal, the TM-PGM alloy anode exhibited material robustness.

While the disclosed apparatus and systems are susceptible to various modifications and alternative forms in implementation thereof, specific embodiments have been shown by way of example in the drawings and have been described in detail herein. However, it should be understood that the present disclosure is not intended to be limited to the particular forms disclosed. Rather, the present disclosure encompasses all modifications, combinations, equivalents, variations, and alternatives falling within the scope of the present disclosure as defined by the following appended claims and their legal equivalents.

What is claimed is:

1. An anode for an electrochemical reduction system, the anode comprising:
a rod or plate comprising at least one alloy of:
at least one transition metal; and
at least one platinum group metal.

2. The anode of claim 1, wherein the at least one platinum group metal comprises ruthenium (Ru).

3. The anode of claim 2, wherein the at least one transition metal is selected from the group consisting of titanium (Ti), vanadium (V), chromium (Cr), zirconium (Zr), niobium (Nb), molybdenum (Mo), hafnium (Hf), tantalum (Ta), and tungsten (W).

4. The anode of claim 2, wherein the at least one transition metal comprises molybdenum (Mo).

5. The anode of claim 2, wherein the at least one transition metal comprises titanium (Ti).

6. The anode of claim 2, wherein the at least one transition metal comprises tantalum (Ta) or tungsten (W).

7. The anode of claim 1, wherein:
the at least one transition metal comprises at least about 50 wt. % of the at least one alloy; and
the at least one platinum group metal comprises less than about 50 wt. % of the at least one alloy.

8. The anode of claim 1, wherein:
the at least one transition metal comprises within a range from about 50 wt. % to about 80 wt. % of the at least one alloy; and
the at least one platinum group metal comprises within a range from about 20 wt. % to about 50 wt. % of the at least one alloy.

9. The anode of claim 1, wherein the at least one alloy comprises a binary alloy of the at least one transition metal and the at least one platinum group metal.

10. The anode of claim 1, wherein the at least one alloy comprises a ternary alloy of the at least one transition metal and the at least one platinum group metal.

11. The anode of claim 1, wherein the at least one alloy comprises only one transition metal and only one platinum group metal.

12. The anode of claim 1, wherein the anode further comprises:
a core consisting substantially of one of:
the at least one transition metal, or
the at least one platinum group metal; and
a region around the core, the region comprising the at least one alloy.

13. The anode of claim 12, wherein the region around the core comprises a plurality of alloys of the at least one transition metal and the at least one platinum group metal.

14. The anode of claim 1, wherein the anode substantially comprises a homogeneous composition of the at least one alloy.

15. A method of forming an anode for an electrochemical reduction system, the method comprising:
forming a rod or plate comprising at least one alloy, comprising forming the at least one alloy of:
at least one transition metal, and
at least one platinum group metal.

16. The method of claim 15:
further comprising, before forming the at least one alloy, electroplating the at least one transition metal onto the at least one platinum group metal or electroplating the at least one platinum group metal onto the at least one transition metal to form an intermediate structure; and
wherein forming the at least one alloy comprises heating the intermediate structure to diffuse the at least one transition metal and the at least one platinum group into one another to form a region comprising multiple alloys of the at least one transition metal and the at least one platinum group metal.

17. An electrochemical reduction system, comprising:
a counter electrode comprising at least one alloy of:
at least one platinum group metal; and
at least one transition metal; and
an electrolyte comprising a molten salt.

18. The electrochemical reduction system of claim 17, wherein the molten salt of the electrolyte comprises a halide-based molten salt.

19. The electrochemical reduction system of claim 17, further comprising a working electrode comprising or supporting at least one oxide selected from the group consisting of oxides of titanium (Ti), zirconium (Zr), hafnium (Hf), vanadium (V), niobium (Nb), tantalum (Ta), chromium (Cr), manganese (Mn), nickel (Ni), molybdenum (Mo), tungsten (W), ruthenium (Ru), osmium (Os), rhodium (Rh), iridium (Ir), iron (Fe), cobalt (Co), silicon (Si), boron (B), lanthanum (La), cerium (Ce), neodymium (Nd), samarium (Sm), dysprosium (Dy), actinium (Ac), thorium (Th), uranium (U), and combinations thereof.

20. The electrochemical reduction system of claim 17, wherein, prior to operation of the electrochemical reduction system, the counter electrode is substantially free of oxygen.
